(19) United States
(12) Patent Application Publication
(10) Pub. No.: US 2003/0060110 A1
(43) Pub. Date: Mar. 27, 2003

(54) Expanded extruded polymeric textile

(76) Inventor: Dilipkumar R. Desai, Cornwall Ontario (CA)

Correspondence Address: David J French, Station D, PO Box 2486, Ottawa, K1P5W6, CA

(21) Appl. No.: 10/168,693

(22) PCT Filed: Dec. 22, 2000
(86) PCT No.: PCT/CA00/01511

(30) Foreign Application Priority Data
Dec. 24, 1999 (CA) 2293147

(51) Int. Cl. B32B 5/18; B32B 3/26; B32B 3/00; B32B 5/16; B32B 27/30; B32B 27/32; B32B 27/12; B32B 5/28; B32B 5/24

(52) U.S. Cl. 442/221; 442/286; 442/288; 442/290; 442/294; 442/370; 442/226; 442/374; 442/375; 442/394; 442/396; 442/398; 442/315; 428/313.3

(57) ABSTRACT

A method of extruding a foamed plastic into a carrier that relies on the use of dual, multiple blowing agents, a dispersed blowing agent and a micro-encapsulated blowing agent. The resulting product is a polymer coated textile that is resilient with good compression rebound.

### FIELD OF THE INVENTION

This invention relates to the field of textiles. In particular, it relates to textiles wherein a polymeric “plastic” layer is bonded to a fabric substrate, and the plastic layer is in the form of a foamed matrix.

### BACKGROUND TO THE INVENTION

In the production of plastic coated textiles, the product has customarily been made by one of the following alternate procedures:

1) casting a plastic layer in paste form onto a fabric carrier;

2) bonding a pre-formed plastic layer onto a fabric carrier by calendering and/or use of adhesives; and

3) extruding a molten plastic layer onto a fabric carrier.

When it has been intended to provide a plastic layer that is “foamed” and resilient due to included gas-filled cells or voids, it has been customary to create the expanded plastic matrix in two stages. First a plastic layer containing a blowing agent in a quiescent state is cast onto a fabric carrier. Then the formed composite textile is exposed to heat which causes gas to evolve within the plastic layer—the process of “blowing”.

A disadvantage of this latter process is that the level of heat that is required to activate the blowing agent will cause carrier components in many types of fabric carriers to fuse, e.g. polyethylene will fuse at 175° F., whereas various types of chemical blowing agents require a temperature in excess of 300° F. to create foaming conditions.

Attempts have been made to incorporate a blowing agent into an extruded plastic to form a foamed plastic layer and then to press the freshly extruded foam into a fabric. However, with the use of conventional chemical blowing agents, this process has produced a textile wherein, due to the foamed polymeric layer's lack of resistance to crushing, a flattened polymeric layer is formed that has almost no or little foam voids left in the structure after being pressed into the fabric. In a standard extrusion procedure for a non-foamed polymer, a chilled embossing roll presses the extruded sheet of melt into a fabric carrier supported by a second, optionally heated, rubber-coated roller where the plastic layer sets, and bonds, with the textile. Extrusion coated textiles prepared with classic blowing agents have typically lacked the resilience to recover sufficiently from this compression step to provide a satisfactorily foamed textile.

A need exists for a foamed plastic composite textile that is formed on a permeable carrier, e.g. a woven, knitted or non-woven fabric, with a low fusing temperature, while exhibiting good recovery or resilience in response to applied pressure. This invention addresses this need as well as providing other advantages.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more e specific forms will then be further described, and defined, in each of the individual claims which conclude this Specification.

### SUMMARY OF THE INVENTION

According to one aspect of the invention, a method of producing a foamed sheet textile is provided as follows:

1) extruding a polymeric melt from a linear extrusion die in the form of a sheet or film with two faces, the melt containing two or more classes of expanding agents:

(a) a first extrusion activated gas generant dispersed within said melt; and

(b) thermally expandable micro-spheres having encapsulating shells each containing compressed gas and being dispersed within said melt

2) allowing the expanding agents to expand, with the gas generant generating gases to form a compressible foamed matrix in the melt and allowing the micro-capsules to expand into compression resistant micro-spheres suspended within said foamed matrix;

3) depositing the melt onto a permeable carrier and into the surface of which the foamed melt partially penetrates; and

4) allowing the foamed polymeric composition so formed to set to provide a resilient compression-resistant, foamed plastic layer that is bonded to the carrier to form the resulting textile.

Suitable carriers include woven, knitted, non-woven compressed and other fiber-based continuous sheet materials as well as permeable polymeric foams and paper.

Preferably, the extrusion melt, upon being laid-down on the permeable carrier, is carried on the carrier through a rotating gate defined by a gap between two rollers, one of the rollers being cooled to set the melt. This establishes a constant height for the foamed layer on the textile. The roller delivering the carrier may be powered, and the second cooled roller may be traction-driven off of the powered roller by end-rims extending from the first, carrier roller.

The resulting product of the invention is a textile (including a paper-based product) having a permeable carrier into the surface of which the foamed plastic layer has expanded while still molten and while the gas generants are still expanding. Thus, the boundary surface of the carrier is at least partially embedded within the foamed plastic layer. Expansion of the foamed layer both above and within the carrier may continue after the formed textile exits the rotating gate.

By inclusion of thermally expandable micro-spheres in the melt the foamed plastic layer contains inclusions of thermally expanded hollow micro-spheres having encapsulating shells that, after expansion, are compression resistant. This allows the melt to be pressed into the carrier while substantially preserving the expanded state of the melt. The presence of micropheres further serves to enhance the resistance to crushing of the final foamed layer of the textile. The dispersed gas generant gives the foamed layer a soft and resilient character which is highly desirable in a coated textile.

An advantage of this process is that polymers such as rubbers (both synthetic and natural), elastomers such as Engage-TM by Dow Chemicals, polymeric vinyl compounds, polypropylene, thermoplastic polyurethanes, styrenes, polyethylene and other conventional polymers may be used to provide the foamed plastic layer, along with blends of such components (hereafter referred to as “suitable polymers”).

Further, a textile may be produced with an integrally-formed skin region present at it's polymer surface, the skin region containing less voids than the intermediate region of the foamed layer lying between the skin region and the carrier. This may be accomplished by cooling the extrusion die through which the melt is extruded as well as by utilizing a cooled gating roller to confine the foaming layer as it is applied to the carrier.

An advantage of this process is that a coated textile can be produced at lower temperatures than those wherein the carrier would otherwise plastically deform, e.g. production can occur at temperatures as low as 300 degrees Fahrenheit, or even 200 degrees Fahrenheit.

To produce the textile, the extruder is fed with a composition suitable for generating a foamed polymer comprising:

1) at least one expandable thermoplastic polymer capable of being extruded;

2) a first extrusion activated gas generant dispersed within said polymer; and

3) thermally expandable compression resistant micro-spheres, disbursed within said polymer;

said generant and micro-spheres being capable on heating of expanding said polymer when released in a heated state from a pressurized extrusion die.

The resulting product is a foamed polymer coated textile having a porous carrier into and over which a foamed melt has expanded while still molten to provide an overlying plastic layer embedded in the boundary surface of the carrier, said foamed plastic layer containing voids produced by a disbursed gas generant and inclusions of thermally expanded, hollow micro-spheres having encapsulating shells that are resistant to compression.

The foregoing summarizes the principal features of the invention and some of its optional aspects. The invention may be further understood by the description of the preferred embodiments, in conjunction with the drawings, which now follow.

### SUMMARY OF THE FIGURES

FIG. 1 is a schematic side view of an extrusion coating line.

FIG. 2 is a cross-sectional side view of an extrusion screw delivering a melt of expanding polymer to the nip of a pair of rollers where the melt becomes bonded to a fabric carrier.

FIG. 3 is a bottom view of the pair of rollers receiving and combining the melt with the fabric.

FIG. 4 is a diagrammatic cross-sectional side view of the foamed polymeric layer bonded to a fabric carrier.

FIG. 5 shows a cross-sectional textile as in FIG. 4 with a second foam layer on top of the first foam layer.

FIG. 6 shows a cross-section of a textile as in FIG. 4 wherein foamed layers are present on both sides of the carrier.

FIG. 7 is a cross-section of a textile as in FIG. 4 with an additional, solid skin layer.

### DESCRIPTION OF THE PREFERRED EMBODIMENT

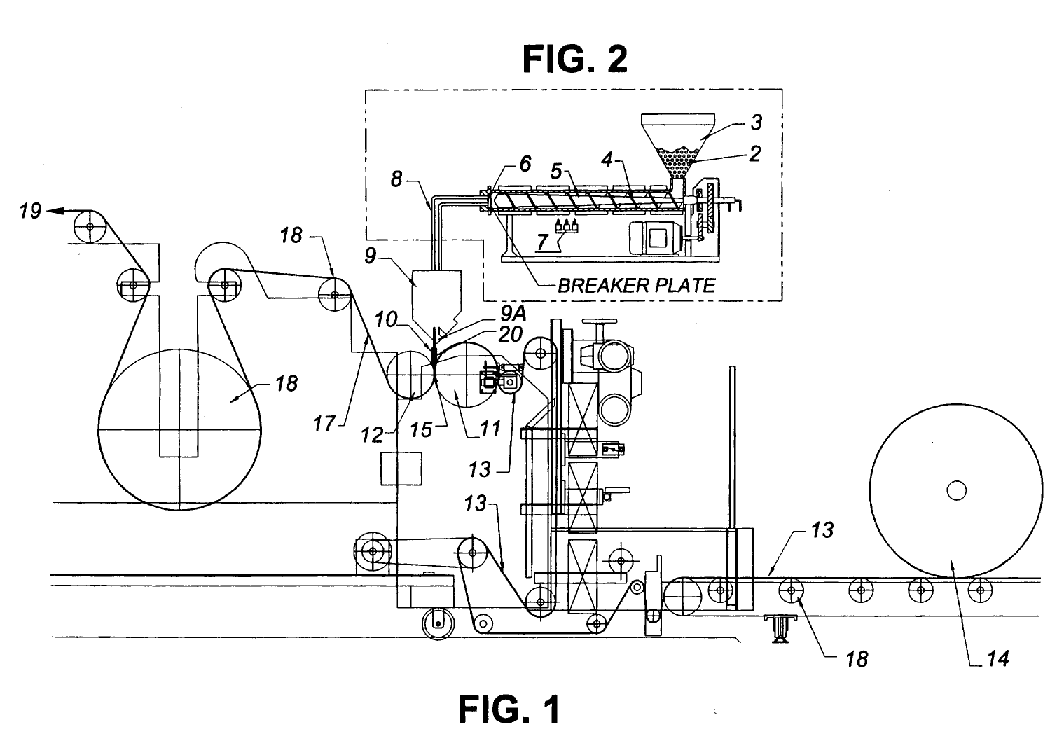

In FIGS. 1 and 2 a powdered plastic composition 2 in powder/pellet form is fed into the feed-hopper 3 of a spiral extruder screw 4. The gap around the spiraled flights 5 of the screw 4 may decrease in width proceeding towards the extruder outlet 6 thus creating an increasing pressure on the melt 8 contained therein. Heat is applied externally from a heat source 7 such as hot oils, gas flames, steam or electric heaters to convert the powdered composition 2 to a melt 8.

Molten plastic composition or “melt” 8 passes from the extruder outlet 6 to the extrusion die 9 and the die lips 9A where the pressure that previously arrested the release of gas by the gas generants (not shown in FIG. 2) is relaxed, allowing the gas generants to “blow” and produce a foamed melt 10. This foamed melt 10 is fed into the nip 15 between two counter rotating rollers 11, 12.

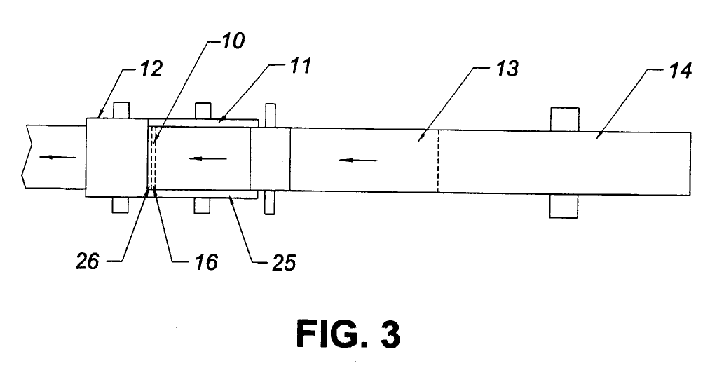

As shown in FIG. 3 one of the rollers 11, preferably a powered roller 11, carries a bondable carrier material 13, of preferable a fabric or fibrous matrix, or paper or previously coated material, from a carrier-source roller 14 to the nip 15. The other follower roller 12, preferably driven in a counter rotating direction by friction off of the powered roller 11, provides with the first roller a gap 16 having a pre-determined dimension at the nip 15 which serves as a gate for metering the thickness of foamed melt 10 that is laid down on the carrier sheet 13. Desirably, the powered roller 11 has a pair of protruding circumferential end rims 25 cut into a compressible surface layer, e.g. of rubber. These rims 25 are positioned to bear against an interface 26 between the first and second rollers 11, 12 whereby a traction drive effect occurs to achieve synchronized speeds that minimize shear forces applied to the foam layer 10. By providing ring 25 of rubber in the first roller 11, the gap 16 width may be adjusted by controlling the distance between the rollers 11, 12 without loss of sychronization.

Preferably, the roller 12 is temperature controlled, e.g. chilled as by circulating chilling fluid coolant, (not shown) or other suitable method of cooling in the normal manner known for extrusion processes. To facilitate heat transfer the formed textile 17 may be partially wrapped around roll 12. optionally, the powered roller 11 may be heated or cooled as circumstances require.

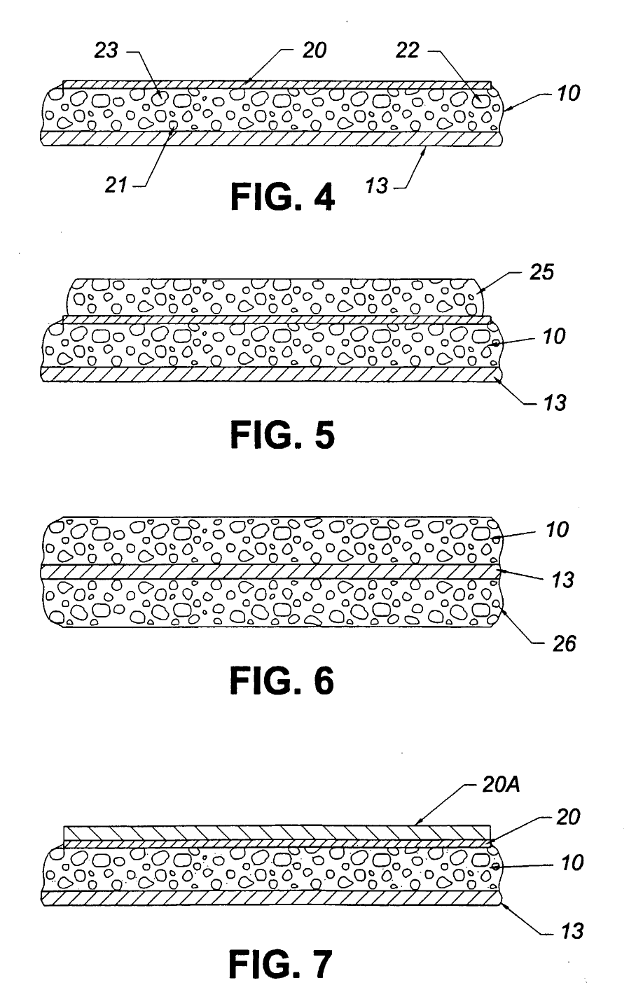

Preferably, the die 9 is also cooled, as by cooling air, oil or other means, to form a skin 20 surface on the foamed melt 10 as it leaves the die 9, cf FIG. 4. This skin 20 has less voids than the core of the foamed layer, e.g. 50% or less.

In the gap 16 the foamed melt 10 continues its expansion, having infiltrated or mixed with the boundary surface of the carrier 13 as it proceeds to set therein. The composite textile 17 exits the two rollers 11, 12 and is carried by a series of conveying and/or cooling rollers 18 to a textile take-up roll 19. Some partial expansion of the foamed layer 10 may occur while the textile 17 is on the conveying rollers 18. As well, expansion within the carrier 13 may also continue.

In the above process, the plastic composition 2 may incorporate or comprise rubber, (both natural and synthetic such as nitrile rubbers) elastomers such as Engage-TM produced by Dow Chemicals, a polymeric vinyl compound, a polypropylene compound, a polyethylene compound, a thermoplastic polyurethane, styrenes or other known and conventional polymeric material, or combinations thereof, suitable for producing foamed plastic coated textiles or carriers. In particular, the plastic composition 2 may include dual expansion agents, comprising:

1) a dispersed blowing agent or gas generant such as azodicarbonamide or other chemical blowing agents or injected compressed gas and/or volatile liquid, and;

2) a micro-encapsulated expansion agent such as EXPANCEL-TM (by Casco Nobel AB of Sweden cf U.S. Pat. No. 5,585,119) or such other encapsulated expansion agents which upon foaming provide compression-resistant micro-spheres within the plastic layer of the final textile 17.

As an alternative or supplement to a chemical blowing agent the compound may contain an injected blowing agent in the form of a gas or volatile liquid.

A typical composition of this invention which is extrudable may contain one or more conventional additives such as fillers, pigments, colorants, plasticisers, stabilizers, anti-oxidants, lubricants and processing aids. Such additives can be used in conventional quantities for formulating an extrudable composition. As additives, this composition 2 may also include conventional binders, such as an acrylic and\or a nitrile rubber, or the like, that serve to constrain and delay the expansion of the foamed melt 10.

By way of exemplification, Table 1 shows typical formulations for a PVC composition which it is believed can be used in accordance with this invention. The preferred formulation has produced satisfactory samples. It is highly desirable that all additives and components of the composition be chlorine-free. In Table 2 formulations for a preferred thermoplastic olefin composition are listed that have provided a satisfactory chlorine-free product, as well as formulations which are believed suitable for producing product. The exact formulation employed will be subject to testing by those knowledgeable in the art to achieve appropriate results.

TABLE 1

WEIGHT IN MIXTURE

| COMPOUND | Preferred | | Range |
|---|---|---|---|
| Polymer:-PVC | 136 | pounds | 100-140 |
| Filler: | 40.7 | pounds | 0-60 |
| e.g. (Omyacarb) (™) | | | |
| Micro-encapsulating blowing | 1.0 | pounds | 0.5-3.5 |
| agent: | | | |
| e.g. (Expancel 092) (™) | | | |
| Dispersed blowing agent: | 4.1 | pounds | 0.5-7.0 |
| e.g. (Celogen 754A) (™) | | | |
| Plasticizer/Co-stabilizer: | 102 | pounds | 42-140 |
| e.g. (Soy Bean Oil) | | | |
| Stabilizer: | 3.7 | pounds | 2.5-7.0 |
| e.g. (Nuostabe) (™) | | | |
| Anti-oxident: | 0.3 | pounds | 0-2.8 |
| e.g. (Irganox) (™) | | | |
| Lubricants: | 3.3 | pounds | 0.5-3.3 |
| e.g. (Internal/external-stearic | | | |
| acid, “Loxiol (™)” and | | | |
| Hostalub (™) | | | |
| Process Aid: | 6.8 | pounds | 0-7.0 |
| e.g. Paralord-(K12ON) (™) | | | |
| Additional Additives | | | 0-14 |
| e.g. fire retardants, anti- | | | |
| static agents, anti-fogging | | | |
| agents; anti-microbial agents | | | |
| pigments | | | |

TABLE 2

| COMPOUND | WEIGHT IN MIXTURE | |
|---|---|---|
| POLYPROPYLENE-FOAM | PREFERRED | RANGE |
| Nitrile Rubber and/or acrylate- | 1630.00 | 800-2400 |
| terpolymer Master-Batch based on | | |
| e.g. Sunnigum G-1 (™) or | | |
| Chemigum (™) | | |
| PP-Copolymer | 800.00 | 600-1600 |
| e.g. Adflex 359P (™) or Adflex- | | |
| KS357P (™) | | |
| PP-Compatibilizer | 32.00 | 16-64 |
| e.g. Lotryl-18MA-02 (™) | | |
| Plasticizer-General Adepate | 37.00 | 0-800 |
| and/or process oils | | |
| e.g. Palatinol GA (™) Sunpar | | |
| Oils (™) | | |
| Filler | 160.00 | 100-800 |
| e.g. Omyacarb 6 (™) | | |
| Lubricant | 16.00 | 8-48 |
| e.g. Hostalub FA1 (™) Licowax PE- | | |
| 840 (™); Calcium Sterate | | |
| Dispersed Blowing Agent | 49.00 | 30-150 |
| e.g. Celogen 754-A (™) | | |
| Microencapsulating Blowing Agent | 37.00 | 30-150 |
| e.g. Expancel 092 (™) | | |
| Anti-oxydent e.g. Irganox- | 50.00 | 50-180 |
| 1010 (™) and/or Hostanox-03 (™) | | |
| and/or Ultranox-641 (™) | | |
| Additional Additives e.g. | | |
| Fire retardants, anti-static | | |
| agents, anti-fogging agents; | | |
| anti-microbial agents, pigments | | |

The resulting textile 17 is thereby rendered resilient and crush resistant. This textile may be further processed by pressure and/or vacuum-forming or injection molding without the foam layer being crushed or destroyed.

A sample textile 17 is depicted in FIG. 4 wherein the foamed layer 10 is bonded to the carrier 13. A thin, thermally formed skin 20 has been created by the chilling effect, as by the cooled gating roller 12. Within the foamed layer 10 are two types of voids: voids 21 in the foamed matrix produced by the dispersed gas generant; and voids 22 present within expanded micro-spheres 23. Each micro-sphere 23 has an encapsulating shell of resilient, compression resistant material. The presence of two types of voids 21, 22 improves the character and “feel” of the final textile product 17.

Previously we observed that the polymer melt may be laid down on a carrier 13 that already includes a foamed layer 10. A second foam layer 25 may be laid down either over the first foamed layer 10 or as a layer 26 on the reverse side of the carrier 13, e.g. over the remaining exposed carrier layer 13, cf FIGS. 5 and 6. In the first case an extended depth of foamed layers with differing degrees of flexibility may be created using a pre-coated carrier 13. In the second case a sandwich construction is created which provides a superior platform for use with pour-in-place urethane foams. The added foam layer 26 can serve to protect a fragile carrier layer 13 from the damaging effects of liquid urethane.

The skin 20 in FIG. 4 may be reinforced by a second layer 20A of solid(non-expanded) skin material a shown in FIG. 7. This protective skin 20A can be formed by multiple passes through an extrusion coating line or by lamination. It may also be formed by co-extrusion methods wherein a single laminating station may be served by two or more extruders.

Conclusion

The foregoing has constituted a description of specific embodiments showing how the invention may be applied and put into use. These embodiments are only exemplary. The invention in its broadest, and more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

The embodiments of the invention in which an exclusive property or privilege is claimed are defined as follows:

1. A method of producing a foamed sheet textile comprising:
1) extruding a polymeric melt from a linear extrusion die in the form of a sheet or film with two faces, the melt containing two or more classes of expanding agents:
(1) a first extrusion-activated gas source dispersed within said melt; and
(2) thermally expandable micro-spheres having encapsulating shells dispersed within said melt
2) allowing the expanding agents to expand, with the gas source generating gases to form a compressible foamed matrix in the melt and allowing the micro-spheres to expand into compression resistant, expanded micro-spheres suspended within said foamed matrix;
3) depositing the melt on the surface of a permeable carrier whereby the foamed melt penetrates said surface; and
4) allowing the foamed polymeric composition so formed to set to provide a resilient, compression-resistant, foamed plastic layer that is bonded to the carrier to form the resulting textile.

2. A method as in claim 1 in combination with cooling means for said extrusion die whereby a skin layer of partially set melt forms on a face of the sheet or film as it exits the die.

3. A method as in claims 1 or 2 in combination with paired counter-rotating rollers forming a gap there between, the first of said rollers conveying the permeable carrier to a contact zone proximate to said gap for contact with the melt, wherein the expanding melt sheet or film is passed into the gap to penetrate the surface of the carrier.

4. A method as in claim 3 wherein the second of said rollers is cooled by cooling means.

5. A method as in claim 3 or 4 wherein the melt, upon coming into contact with and penetrating into the surface of the permeable carrier passes through the gap which serves as a rotating gate defined by a fixed separation between said two rollers to thereby limit the height of the melt deposited on the carrier.

6. A method as in claim 5 wherein the first roller is powered and has protruding circumferential end rims which bear upon the second roller thereby actuating the second roller by traction.

7. A method as in claim 6 wherein the first roller carries resilient end rims which bear against the second roller to drive the second roller at a sychronized speed to minimize shear forces applied to the expanding melt sheet or film.

8. A method as in claim 5 wherein the melt deposited on the carrier retains sufficient temperature after passing through the gate to permit the melt to continue to expand within the carrier and to expand its height above the carrier after passing through the gate.

9. A method as in claim 1 wherein the melt comprises rubber or elastomers and further comprises as its principal polymeric component other than such rubber or elastomers a polymeric composition selected from the group of compounds consisting of polyvinyl chloride, polyethylene, polypropylene, styrenes, thermoplastic urethane, and combinations thereof.

10. A method as in claim 9 wherein the principal polymeric component of the melt other than rubber or elastomers comprises principally polyvinyl chloride in combination with additives.

11. A method as in claim 9 wherein the polymeric components of the melt are substantially chlorine-free.

12. A method as in claim 11 wherein the principal polymeric component of the melt other than rubber or elastomers comprises principally polypropylene in combination with additives.

13. A method as in claim 11 wherein the principal polymeric component of the melt other than rubber or elastomers comprises principally polyethylene in combination with additives.

14. A method as in claim 11 wherein the principal polymeric component of the melt other than rubber or elastomers comprises principally styrenes in combination with additives.

15. A resilient, foamed, polymeric textile comprising a permeable carrier with first and second outer surfaces having an overlying, foamed polymeric layer at least partially embedded into said first outer surface of the carrier, said foamed polymeric layer containing inclusions of thermally expanded hollow micro-spheres having encapsulating shells that are resistant to compression.

16. A textile as in claim 15 wherein the foamed polymeric layer comprises as its principal polymeric component other than rubber or elastomers, a composition selected from the group of compounds consisting of polyvinyl chloride, polyethylene and polypropylene styrenes and thermoplastic urethane and combination thereof.

17. A textile as in claim 16 wherein the polymeric component of the foamed polymeric layer consists principally of polyvinyl chloride in combination with additives.

18. A textile as in claim 16 wherein the polymeric components of the foamed plastic layer are substantially chlorine-free.

19. A textile as in claim 18 wherein the foamed polymeric layer comprises apart from rubber or elastomers, principally polypropylene in combination with additives which are substantially chlorine-free.

20. A textile as in claim 18 wherein the foamed polymeric layer comprises apart from rubber or elastomers principally polyethylene in combination with additives which are substantially chlorine-free.

21. A textile, as in claim 18 wherein the foamed polymeric layer comprises apart from rubber or elastomers principally styrenes in combination with additives which are substantially chlorine-free.

22. A textile as in claims 15, 16, 17, 18, 19, 20, or 21 comprising an effective amount of elasticizing agent selected from the group consisting of rubber or elastomers and combinations thereof to render the textile resilient.

23. A textile as in claims 15, 16, 17, 18, 19, 20, 21, or 22 wherein said fold polymeric layer has a surface opposite said carrier with an integrally-formed skin region present at said surface, the skin region containing less voids than the intermediate region of the foamed layer lying between the skin region and the carrier.

24. A textile as in claim 23 wherein the percentage of voids in the skin region is less than 50% of the percentage of voids in the intermediate region.

25. A textile as in claim 23 wherein said foamed polymeric layer has a second polymeric skin layer on its surface, opposite said carrier, wherein said second skin layer is substantially free of voids.

26. A textile as in claims 15, 16, 17, 18, 19, 20, 21, 22 or 23 wherein the foamed polymeric layer is a first foamed layer, said textile having a second foamed layer present over said first foamed layer

27. A textile as in claims 15, 16, 17, 18, 19, 20, 21, 22, 23, 24 or 25 wherein the foamed polymeric layer is a first foamed layer, said textile having an additional foamed layer present over the second carrier surface, opposite to said first foamed layer.

28. A textile as in claims 15, 16,17, 18, 19, 20, 21, 22, 23, 24, 25, 26, or 27 wherein said, carrier is a fibrous matrix.

29. A textile as in claims, 15, 16, 17, 18, 19, 20, 21, 22, 23, 24, 25, 26 or 27 wherein said carrier is a paper.

30. A textile as in claim 15, 16, 17, 18, 19, 20, 21, 22, 23, 24, 25, 26, 27, or 28 wherein said carrier deforms at temperatures above 150 degrees Centigrade.

31. A textile as in claims 30 wherein said carrier deforms at temperatures above 95 degrees Centigrade

32. A composition suitable for generating a foamed polymer comprising:
1) at least one expandable thermoplastic polymer capable of being extruded;
2) a first extrusion activated gas generant dispersed within said polymer; and
3) thermally expandable, hollow, compression resistant micro-spheres, disbursed within said polymer;
said source and micro-spheres being capable, on heating, of expanding said polymer when released in a heated state from a pressurized extrusion die.

33. A composition as defined in claim 32 further comprising at least one additive chosen from fillers, plasticisers, stabilizers, fire retardants, anti-oxidants, anti-static agents anti-fogging agents, processing aids, colorants and lubricants.

34. A composition as defined in claim 32 wherein the polymer comprises as its principal component other than rubber or elastomer a composition selected from the group of compounds consisting of polypropylene, polyethylene, polyvinyl chloride polymer or copolymer, styrenes and combinations thereof.

35. A composition as in claim 34 wherein the composition comprises an effective amount of elasticizing agent selected from the group consisting of rubber or elastomer and combinations thereof to render said composition, when expanded and set, resilient.
